(19) United States
(12) Patent Application Publication
(10) Pub. No.: US 2014/0006172 A1
(43) Pub. Date: Jan. 2, 2014

(54) METHOD OF CALCULATING A RESERVE PRICE FOR AN AUCTION AND APPARATUS CONDUCTING THE SAME

(71) Applicants: David Pardoe, Sunnyvale, CA (US); Patrick R. Jordan, Mountain View, CA (US); Chris Bartels, Sunnyvale, CA (US)

(72) Inventors: David Pardoe, Sunnyvale, CA (US); Patrick R. Jordan, Mountain View, CA (US); Chris Bartels, Sunnyvale, CA (US)

(73) Assignee: Yahoo! Inc., Sunnyvale, CA (US)

(21) Appl. No.: 13/539,270

(22) Filed: Jun. 29, 2012

(51) Int. Cl. G06Q 30/08

(52) U.S. Cl. 705/14.71

(57) ABSTRACT

The present application relates to systems and computer-implemented methods for calculating a suggested reserve price associated with an opportunity to realize an online advertisement. In some implementations, a database of historical online advertisement auctions is established; historical online advertisement auctions from the database of historical online advertisement auctions that are associated with a feature are clustered to form a cluster; a reserve price associated with the cluster of historical online advertisement auctions is calculated to generate a desired revenue; and the reserve price is stored as a suggested reserve price for the opportunity to realize the online advertisement that is associated with the feature.

### BACKGROUND

Online advertising is a form of promotion that uses the Internet and the World Wide Web to deliver marketing messages to attract customers. Examples of online advertising include contextual ads on search engine results pages, banner ads, blogs, Rich Media Ads, Social network advertising, interstitial ads, online classified advertising, advertising networks, and e-mail marketing. Right Media Exchange (RMX) is a marketplace of online advertising that enables advertisers, publishers, and ad networks to trade digital media through an application programming interface. Through a form of online advertisement auction, RMX provides publishers, i.e., media sellers, the visibility and control that provides the ability to maximize yield while driving engagement and return on advertisement spending for media buyers.

One of the key problems publishers face within the RMX online advertisement auction today is how to set reserve (floor) prices, which is a minimum price the publisher wishes a winning bidder to pay, on their inventory. The problem becomes particularly acute as more of the online advertisement auctions move from a first-price rule, where the winning advertiser pays its bid, to a second-price rule, where the winning advertiser pays the minimum amount required to outbid the second-highest competitor.

Auction theory provides a compelling framework for how to set reserve prices based on bidder valuations. However, various aspects of online advertisement auctions for display advertisements complicate the standard machinery. Particularly, in the context of online advertisement auctions for RMX, where the bid of an advertisement on a particular page may vary significantly according to which user is viewing the ad, the dynamic and interrelated nature of advertising inventory makes finding similar historical online advertisement auctions difficult. On the other hand, the expressive nature of RMX allows advertisers to condition their bids upon various user demographic and behavioral features, and with the inclusion of real-time bidding, advertisers may condition their bids upon information through the use of third-party information brokers.

### BRIEF DESCRIPTION OF THE DRAWINGS

The described systems and methods may be better understood with reference to the following drawings and description. Non-limiting and non-exhaustive embodiments are described with reference to the following drawings. The components in the drawings are not necessarily to scale, emphasis instead being placed upon illustrating the principles of the invention. In the drawings, like referenced numerals designate corresponding parts throughout the different views.

FIG. 1 is a schematic diagram illustrating an example embodiment of a network environment;

FIG. 2 is a schematic diagram illustrating an example embodiment of a client device;

FIG. 3 is a schematic diagram illustrating an example embodiment of a server;

FIG. 4 illustrates one procedure of an online advertisement auction;

FIG. 5 illustrates one implementation of an auction scheme using a second-price rule;

FIG. 6 illustrates one implementation of a database of historical online advertisement auctions;

FIG. 7 illustrates a section of the database of historical online advertisement auctions illustrated in FIG. 6;

FIG. 8 illustrates one implementation of a procedure for a publisher to set a reserve price for an opportunity of online advertisement display;

FIG. 9 is the flow chart of one implementation of a computer-implemented Post-Hoc Optimal Method for calculating a suggested reserve price of a cluster;

FIG. 10 is the flow chart of one implementation of Brute-Force Parameter Method for calculating a suggested reserve price of a cluster; and

FIG. 11 is the flow chart of one implementation of computer-implemented Brute-Force Parameter Method for calculating a suggested reserve price of a cluster.

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments.

Example embodiments of the present application relate to computer-implemented methods of calculating a suggested reserve price for an online advertisement auction that is associated with an opportunity to display an online advertisement. In some implementations, the suggested reserve price is calculated in order for a holder of the auction, i.e., a publisher, to maximize and/or obtain desired revenue. For better understanding of the present application, network environments and online advertising that example embodiments of the present application may be implemented are first introduced as follow.

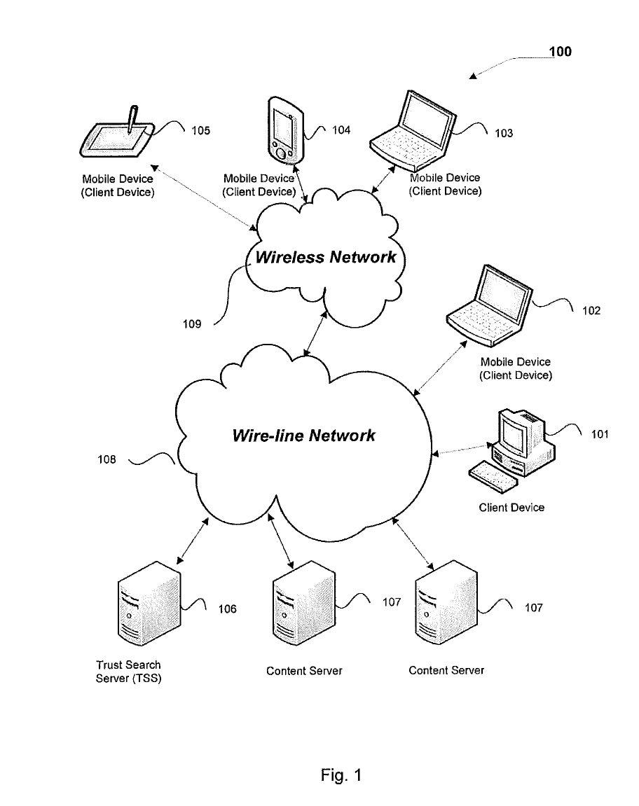

FIG. 1 is a schematic diagram of one embodiment illustrating a network environment that the methods in the present application may be implemented. Other embodiments of the network environments that may vary, for example, in terms of arrangement or in terms of type of components, are also intended to be included within claimed subject matter. As shown, FIG. 1, for example, a network 100 may include a variety of networks, such as Internet, one or more local area networks (LANs) and/or wide area networks (WANs), wire-line type connections 108, wireless type connections 109, or any combination thereof. The network 100 may couple devices so that communications may be exchanged, such as between servers (e.g., content server 107 and search server 106) and client devices (e.g., client device 101-105 and mobile device 102-105) or other types of devices, including between wireless devices coupled via a wireless network, for example. A network 100 may also include mass storage, such as network attached storage (NAS), a storage area network (SAN), or other forms of computer or machine readable media, for example.

A network may also include any form of implements that connect individuals via communications network or via a variety of sub-networks to transmit/share information. For example, the network may include content distribution systems, such as peer-to-peer network, or social network. A peer-to-peer network may be a network employ computing power or bandwidth of network participants for coupling nodes via an ad hoc arrangement or configuration, wherein the nodes serves as both a client device and a server. A social network may be a network of individuals, such as acquaintances, friends, family, colleagues, or co-workers, coupled via a communications network or via a variety of sub-networks. Potentially, additional relationships may subsequently be formed as a result of social interaction via the communications network or sub-networks. A social network may be employed, for example, to identify additional connections for a variety of activities, including, but not limited to, dating, job networking, receiving or providing service referrals, content sharing, creating new associations, maintaining existing associations, identifying potential activity partners, performing or supporting commercial transactions, or the like. A social network also may generate relationships or connections with entities other than a person, such as companies, brands, or so-called ‘virtual persons.’ An individual's social network may be represented in a variety of forms, such as visually, electronically or functionally. For example, a “social graph” or “socio-gram” may represent an entity in a social network as a node and a relationship as an edge or a link. Overall, any type of network, traditional or modern, that may facilitate information transmitting or advertising is intended to be included in the concept of network in the present application.

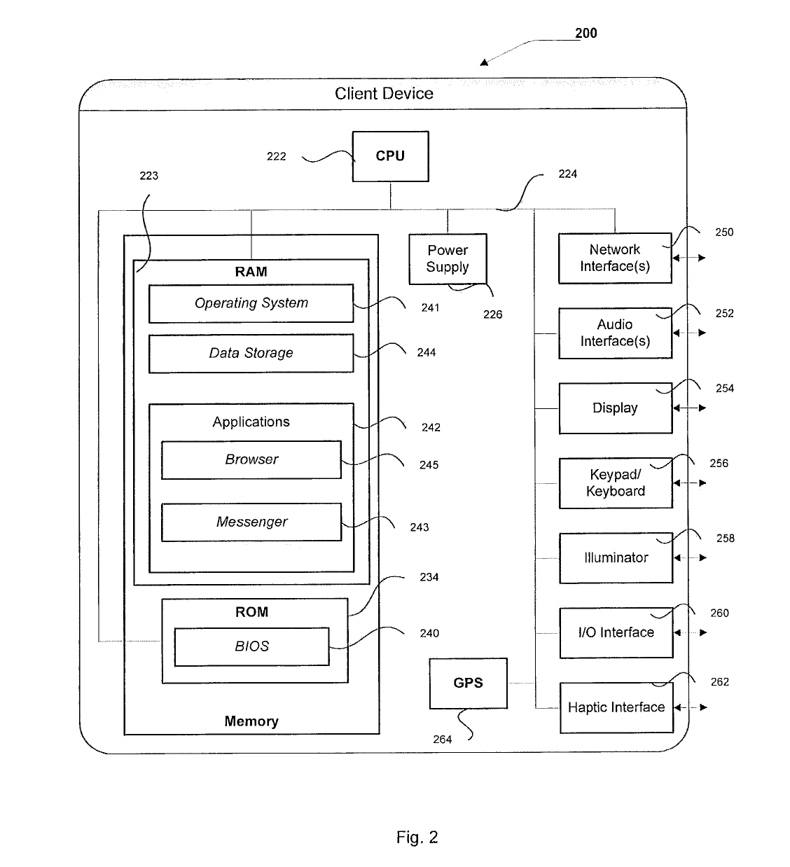

FIG. 2 is a schematic diagram illustrating an example embodiment of a client device. A client device may include a computing device capable of sending or receiving signals, such as via a wired or a wireless network. A client device may, for example, include a desktop computer 101 or a portable device 102-105, such as a cellular telephone or a smart phone 104, a display pager, a radio frequency (RF) device, an infrared (IR) device, a Personal Digital Assistant (PDA), a handheld computer, a tablet computer 105, a laptop computer 102-103, a set top box, a wearable computer, an integrated device combining various features, such as features of the forgoing devices, or the like.

A client device may vary in terms of capabilities or features. Claimed subject matter is intended to cover a wide range of potential variations. For example, a client device may include a keypad/keyboard 256 or a display 254, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) 264 or other location-identifying type capability, or a display with a high degree of functionality, such as a touch-sensitive color 2D or 3D display, for example.

A client device may include or may execute a variety of operating systems 241, including a personal computer operating system, such as a Windows, iOS or Linux, or a mobile operating system, such as iOS, Android, or Windows Mobile, or the like. A client device may include or may execute a variety of possible applications 242, such as a browser 245 and/or a messenger 243. A client application 242 may enable communication with other devices, such as communicating one or more messages, such as via email, short message service (SMS), or multimedia message service MMS), including via a network, such as a social network, including, for example, Facebook, LinkedIn, Twitter, Flickr, or Google, to provide only a few possible examples. A client device may also include or execute an application to communicate content, such as, for example, textual content, multimedia content, or the like. A client device may also include or execute an application to perform a variety of possible tasks, such as browsing, searching, playing various forms of content, including locally stored or streamed video, or games such as fantasy sports leagues). The foregoing is provided to illustrate that claimed subject matter is intended to include a wide range of possible features or capabilities.

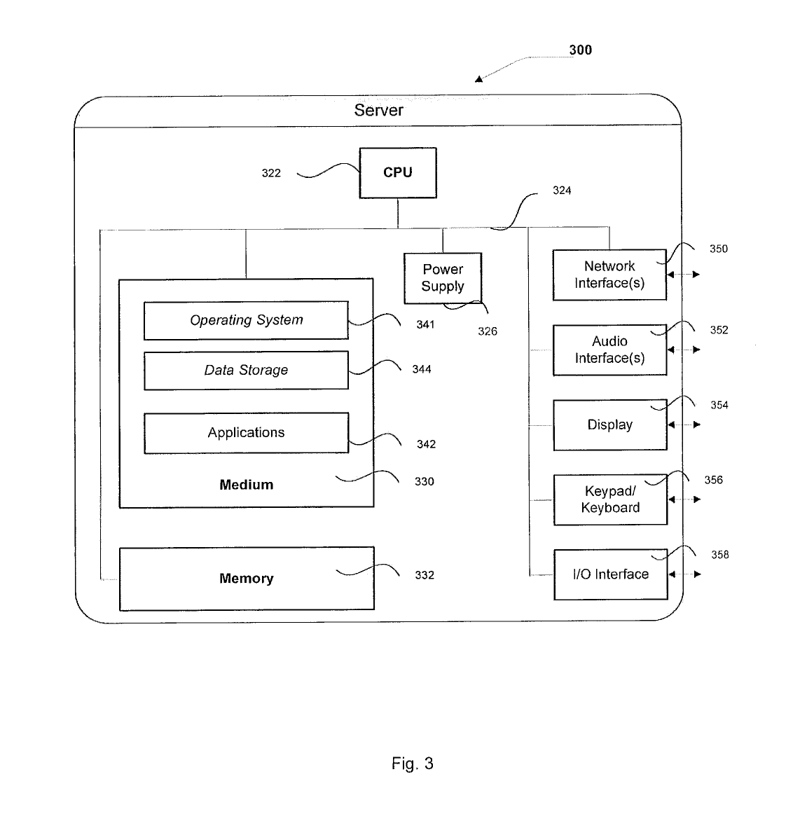

FIG. 3 is a schematic diagram illustrating an example embodiment of a server. A Server 300 may vary widely in configuration or capabilities, but it may include one or more central processing units 322 and memory 332, one or more medium 630 (such as one or more mass storage devices) storing application programs 342 or data 344, one or more power supplies 326, one or more wired or wireless network interfaces 350, one or more input/output interfaces 358, and/or one or more operating systems 341, such as Windows Server, Mac OS X, Unix, Linux, FreeBSD, or the like. Thus a server 300 may include, as examples, dedicated rack-mounted servers, desktop computers, laptop computers, set top boxes, integrated devices combining various features, such as two or more features of the foregoing devices, or the like.

The server 300 may serve as a search server 106 or a content server 107. A content server 107 may include a device that includes a configuration to provide content via a network to another device. A content server may, for example, host a site, such as a social networking site, examples of which may include, but are not limited to, Flicker, Twitter, Facebook, LinkedIn, or a personal user site (such as a blog, vlog, online dating site, etc.). A content server 107 may also host a variety of other sites, including, but not limited to business sites, educational sites, dictionary sites, encyclopedia sites, wikis, financial sites, government sites, etc. A content server 107 may further provide a variety of services that include, but are not limited to, web services, third party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example. Examples of devices that may operate as a content server include desktop computers, multiprocessor systems, microprocessor type or programmable consumer electronics, etc.

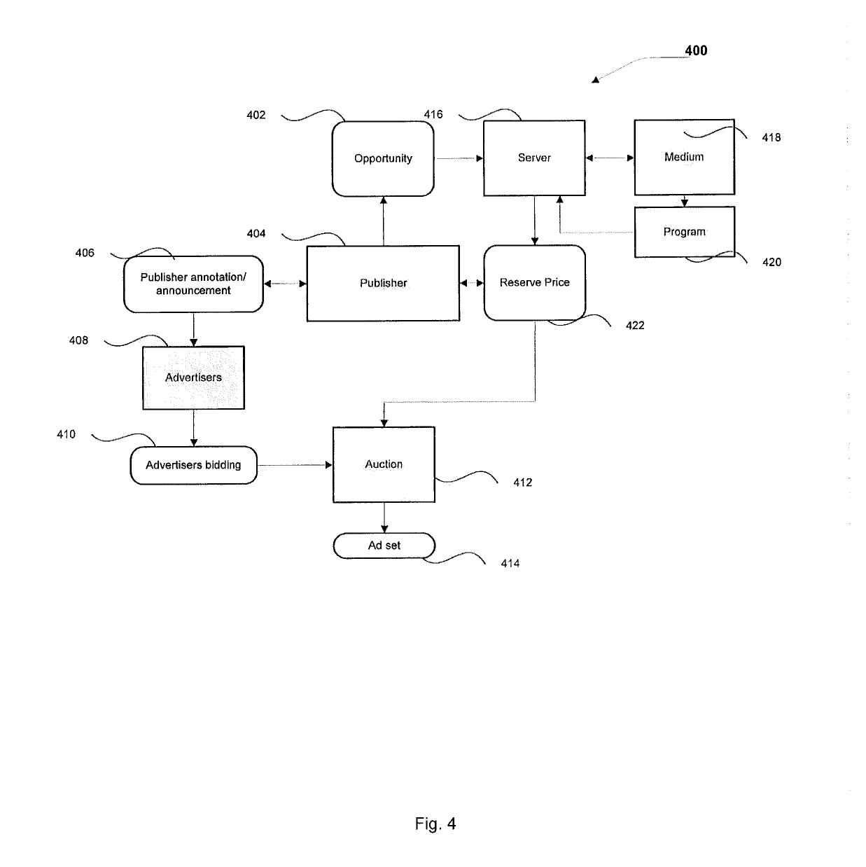

FIG. 4 is a block diagram of one example embodiment illustrating one implementation of a procedure of an online advertisement auction. However, it should be appreciated that the systems and methods described below are not limited to use with an auction for online advertisement display. In the context of RMX, a webpage of a publisher 404 may be viewed by various viewers and/or internet users for a number of times in a particular time period. Every time when a webpage of a publisher 404 is viewed, an online advertising opportunity 402 is created. The publisher 404 may monetize the opportunity 402 by providing the opportunity 402 for advertisers 408, who are targeting their advertisements to specific users, to realize an online advertisement on that webpage through ad network/exchanges. Here, “ad exchanges” may be an organization system that associates advertisers or publishers, such as via a platform to facilitate buying or selling of online advertisement inventory from multiple ad networks; and “ad networks” may refer to aggregation of ad space supply from publishers, such as for provision en masse to advertisers. The advertiser may be any interested parties and the realization may be of any form. For convenient purposes, the present application uses display of an advertisement impression as an example of advertisement realization, but it should be noted that the description intends to include all forms of realization associated with online advertisements. For example, realization of an online advertisement may include an impression of an online advertisement, a click-through associated with an online advertisement, an action associated with an online advertisement, an acquisition associated with an online advertisement, a conversion associated with an online advertisement, or any other type of realization associated with an online advertisement that is known in the art.

For web portals like Yahoo!, advertisements may be displayed on web pages resulting from a user-defined search based at least in part upon one or more search terms. Advertising may be beneficial to users, advertisers or web portals if displayed advertisements are relevant to interests of one or more users. Thus, a variety of techniques have been developed to infer user interest, user intent or to subsequently target relevant advertising to users. One approach to presenting targeted advertisements may include employing demographic characteristics (e.g., age, income, sex, occupation, etc.) for predicting user behavior, such as by group. Advertisements may be presented to users in a targeted audience based at least in part upon predicted user behavior(s). Another approach may include profile-type ad targeting. In this approach, user profiles specific to a user may be generated to model user behavior, for example, by tracking a user's path through a web site or network of sites, and compiling a profile based at least in part on pages or advertisements ultimately delivered. A correlation may be identified, such as for user purchases, for example. An identified correlation may be used to target potential purchasers by targeting content or advertisements to particular users.

Thus, for each online advertisement to be shown, the publisher 404 may contact advertisers 408 that may be interested in the online advertisement display opportunity 402 with relevant information/features thereof. The relevant information/features may include, but may not be limited to, an advertisement key word, website visiting information, information related to where the advertisement will be shown (such as the section of a webpage, a Uniform Resource Locater (URL) of the webpage, a location on the webpage, and/or a size of the advertisement on the webpage) and/or information about the viewers (such as their demographic information, geographic information, and/or information stored in cookies of their computer and/or internet surfing devices) of this opportunity.

Once the advertisers 408 received an annotation 406 of the online advertisement display opportunity 402 from the publisher 404, the publisher 404 may seek monetize the online advertisement display opportunity 402 by holding an online advertisement auction 412 among the advertisers 408.

Various monetization techniques or models may be used in connection with sponsored search advertising, including advertising associated with user search queries, or non-sponsored search advertising, including graphical or display advertising. In an auction-type online advertising marketplace, advertisers may bid in connection with placement of advertisements, although other factors may also be included in determining advertisement selection or ranking. Bids may be associated with amounts advertisers pay for certain specified occurrences, such as pay-per-impression, pay-per-click, pay-per-acquisition, or any other online advertisement auction methodology known in the art. Advertiser payment for online advertising may be divided between parties including one or more publishers or publisher networks, one or more marketplace facilitators or providers, or potentially among other parties. Some models may include guaranteed delivery advertising, in which advertisers may pay based at least in part on an agreement guaranteeing or providing some measure of assurance that the advertiser will receive a certain agreed upon amount of suitable advertising, or non-guaranteed delivery advertising, which may include individual serving opportunities or spot market(s), for example. In various models, advertisers may pay based at least in part on any of various metrics associated with advertisement delivery or performance, or associated with measurement or approximation of particular advertiser goal(s). For example, models may include, among other things, payment based at least in part on cost per impression or number of impressions, cost per click or number of clicks, cost per action for some specified action(s), cost per conversion or purchase, or cost based at least in part on some combination of metrics, which may include online or offline metrics, for example.

The online advertisement auction 412 may adopt a second-price rule with a reserved price 422 set by the publisher 404 prior to the auction 412. To this end, the publisher 404 may send the information of the opportunity 402 to a server 416. The server 416 may search a database of historical online advertisement auctions stored in a medium 418, such as a computer-readable storage medium, through set of instructions stored in the medium 418 and return to the publisher 404 a suggested reserve price. The publisher 404 may then use the suggested reserve price as a reference value for the reserve price 422 and conduct the online advertisement auction 412.

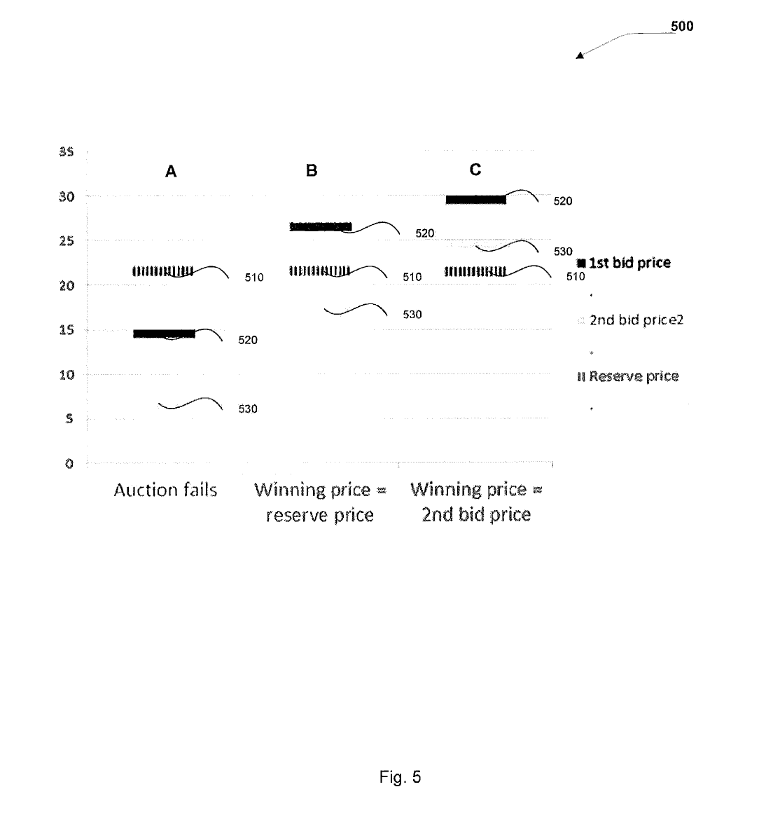

FIG. 5 is a schematic illustration of one implementation of an auction scheme using the second-price rule with a reserve price. According to FIG. 5, the publisher 404 may set a reserve-price 510 prior to the online advertisement auction 412. When the online advertisement auction 412 ends, the value of the reserve price 510 with the highest bid price (the 1^{st} bid price 520) and the second highest bid price (the 2^{nd} bid price 530) may be compared. If the 1^{st} bid price 520 is lower than the reserve price 510, as shown in category A, the auction may be cancelled and the opportunity to display an online advertisement may fail to be sold in the auction. If the 1^{st} bid price 520 is equal to or higher than the reserve price 510, the advertiser that bids the highest price may pay either the reserve price 510 or the 2^{nd} bid price 530, whichever is higher. For example, the wining advertiser may pay the reserve price 510 if the reserve price 510 is higher than the 2^{nd} bid price, as shown in category B, or the winning advertiser may pay the 2^{nd} bid price 530 if the reserve price is lower than the 2^{nd} bid price, as shown in category C.

Since the revenue of an auction depends not on the 1^{st} bid price 520 but on the highest of reserve price 510 and 2^{nd} bid price 530, from a perspective of a publisher, a more favorable situation is to set the reserve price 510 as high as possible but not to exceed the 1^{st} bid price (where the auction fails). But due to the random nature of the biding prices in an individual auction, a higher reserve price may increase the risk of cancelling an online advertisement auction. Thus, a wiser strategy may be to balance the revenue of an auction and the risk of the auction being cancelled to compute a suggested reserve price that may statistically provide the highest and/or desired revenue expectation, according to the opportunity to display an advertisement.

Referring back to FIG. 4, in some implementations, a database of historical online advertisement auctions may be stored in the medium 418 of the server 416 for use in computing the suggested reserve price. The medium 418 may be a computer readable storage medium or any other suitable storage medium. The server 416 may be a personal computer, a workstation, or a terminal in a network. The medium 418 may connect directly to the server or connect indirectly to the server, through physical connection or through wireless communications.

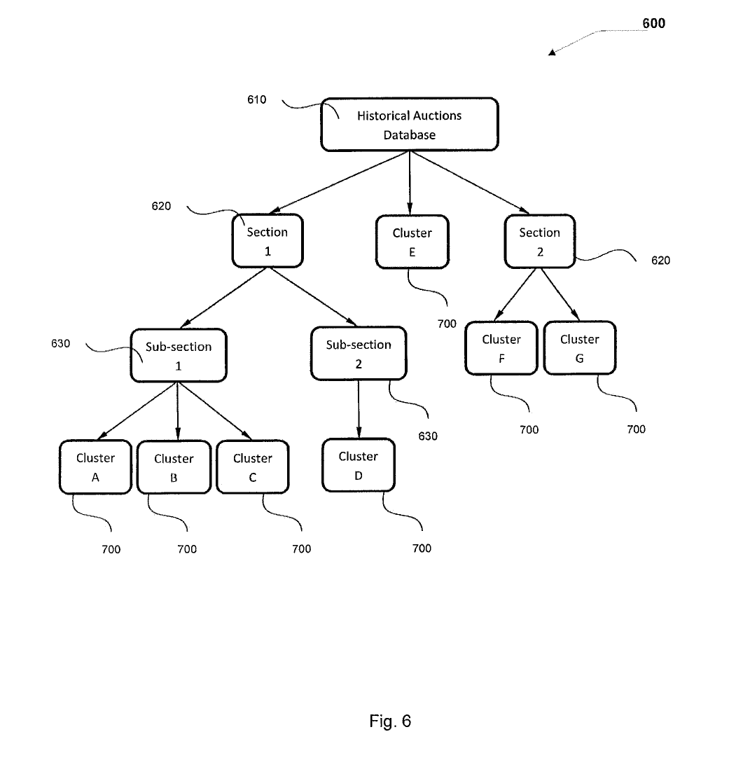

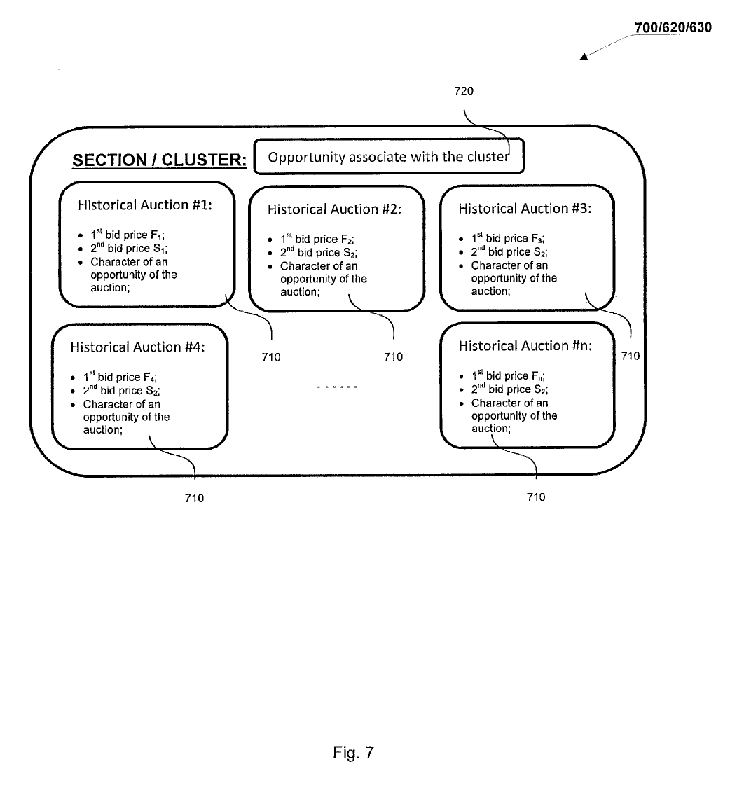

FIG. 6 illustrates one implementation of a database of historical online advertisement auctions and FIG. 7 illustrates a section and/or a cluster of the database of historical online advertisement auctions illustrated in FIG. 6. As shown in FIGS. 6 and 7, the database 610 of historical online advertisement auctions may be divided into a plurality of sections 620, subsections 630, and clusters 400. Each of the sections 620, subsections 630, and clusters 400 may cluster data of a plurality of historical online advertisement auctions 710. Each historical online advertisement auction 710 datum may include information of its outcome as well as the opportunity that is associated with the historical online advertisement auction, so that historical online advertisement auctions with similar characters of opportunity share similar bidding behavior.

For example, each historical online advertisement auction datum may include information associated with its bidders and/or its top two bids, i.e., the 1^{st} bid price and the 2^{nd} bid price; and the opportunity of each historical online advertisement auction may include, but is not limited to, information of an advertisement key word, website visiting information, information related to where the advertisement will be shown (such as the section of its webpage, a URL of the webpage, a location of the advertisement on the webpage, and/or a size of the advertisement on the webpage) and/or information about viewers and/or bidders (such as demographic information, geographic information, and/or information stored in cookies) of this opportunity.

Further, each section 620 may contain historical online advertisement auctions 710 associated with similar opportunities, i.e., each opportunity that is associated with a historical online advertisement auction 710 may have similar features with that of a reference opportunity 720. For example, each opportunity that is associated with a historical online advertisement auction in one section may include a feature that the user of the webpage on which the online advertisement was displayed is a male and more than 65 years old. As a result, sections 620 are mutually exclusive, and an opportunity of an online historical auction may only match one section. If a section is large and/or not refine enough, the section may be further divided into sub-sections 630 with finer categorized characters of the opportunities until bidding behaviors of the historical online advertisement auctions 710 in each individual sub-section 630 may remain substantially consistent.

The server may divide a section 620 into subsections 630 using a straightforward decision-tree-based approach, in which the server may discretize a joint distribution over the 1^{st} and 2^{nd} bid prices into equal-count bins, treat the bin as the class label, and pass the data set into a C4.5 decision tree. For example, the 1^{st} bid prices and 2^{nd} bid prices may be discretized into a number of levels according to their values, wherein each level is called a “bin” and is represented by a number, such as 1, 2, 3, . . . N. Thus if level 5 represents a price between $0.91 and $1.20, and level 6 represents a price between $1.21 and $1.50, a bidding price of $1.50 may be classified as bin No. 6 and a bidding price of $0.95 may be classified as bin No. 5. Accordingly, for an historical auction in which the 1^{st} bid price is $1.50 and the 2^{nd} bid price is $0.95, the outcome (1^{st} bid price=$1.50, 2^{nd} hid price=$0.95) may be mapped to (6, 5). This cross product expression of (1^{st} bid price bin, 2^{nd} bid price bin) may be used to label the historical auctions. Thus for N=10, i.e., there are ten bins for both the 1^{st} bid price and the 2^{nd} bid price, there will be one hundred 1^{st} bid price bin and 2^{nd} bid price bin combinations to label the historical auctions. To discretize the bid prices into equal-count bins, endpoints (i.e., price ranges) of each bin may be careful selected such that an equal number of bids fall into each bin. For example, the discretization for the 1^{st} bid might be: <$0.20 is bin 1, between $0.21 and $0.45 is bin 2, etc. Further, since the distribution of the 1^{st} bid prices and 2^{nd} bid prices may differ from each other, the endpoints of each bin for the 1^{st} bid prices and the 2^{nd} bid prices may be separately selected.

It should be noted that the equal-count bin method above is merely an example to build a tree. Any other method may be used to build the database 610 into a tree, such as regression trees, which can handle real valued labels.

Referring back to FIG. 6, each leaf of the tree then is named as a cluster 700 featured with a reference opportunity 720 associated with the section 700 for displaying an online advertisement, wherein the features of the opportunity associated with each historical online advertisement auction 710 in the cluster 700 is substantially similar to the features of the reference opportunity 720, i.e., cluster 700 are mutually exclusive, wherein an opportunity of an online historical auction may only match one cluster. Further, the size of each cluster 700 may cluster at least 5000 historical online advertisement auctions 710 that associate with similar opportunities.

After the database construction is completed, the server 416 may update the data in the clusters 400 periodically. Once the clusters 400 are updated, the server 416 may obtain and/or compute desired data for each cluster 700 periodically and store the desired data in the medium 418. The period to update the data of clusters 400 may or may not be the same as the period to compute and/or update the desired data for a cluster 700. For example, clusters 400 may be updated and/or selected daily using all data from the past week while the desired data of a cluster 700 may be re-calculated hourly using the last hour of data for that cluster 700. The desired data may include, but may not be limited to, information related to the mean and variance of the 1^{st} and 2^{nd} bids prices, and/or the individual probability distributions and/or joint probability distribution over the 1^{st} and 2^{nd} bid prices of a cluster, and/or a suggested reserve price for the cluster 700.

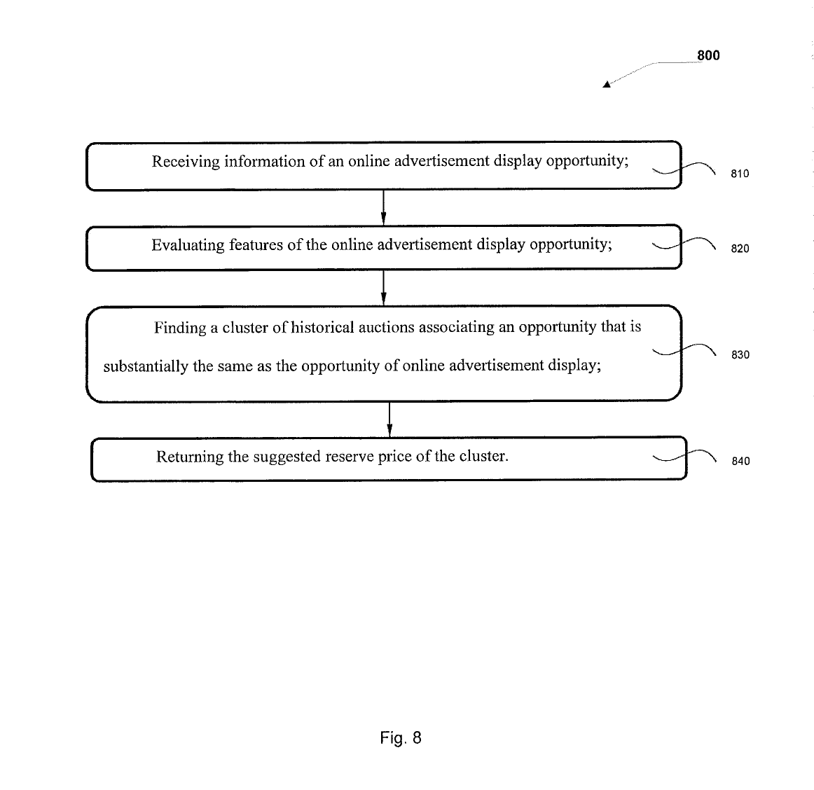

FIG. 8 illustrates one implementation of a procedure for a publisher to set a reserve price for an opportunity of online advertisement display. When a webpage of a publisher is viewed and an opportunity 402 of online advertisement display is created at step 810, the publisher may evaluate the opportunity 402 at step 820. At step 830, the publisher may search the opportunities that are associated with clusters of the database 610 and find an opportunity of a cluster 700 that is substantially similar to the opportunity of the present online advertisement display. For example, the opportunity of the present online advertisement display may be evaluated by starting at the root of the tree 600 and following the appropriate branch until a cluster is reached. The publisher may then use the suggested reserve price of the cluster 700 as a reserve price for the online advertisement display auction, as shown in step 840.

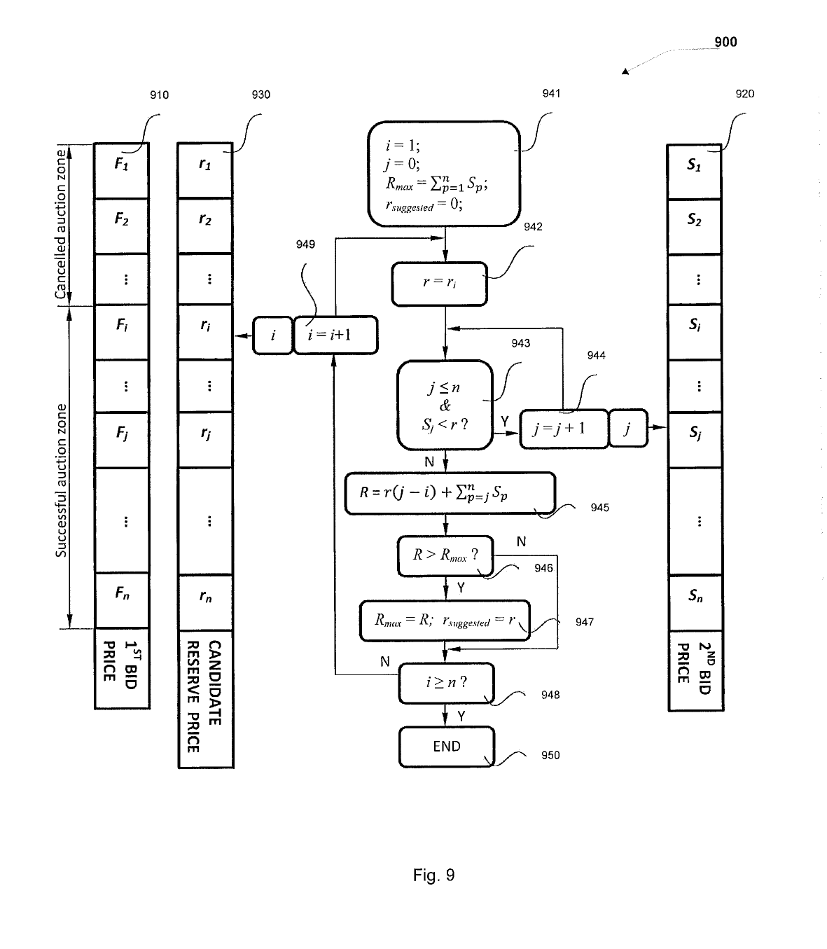

FIG. 9 is a flow chart of one implementation of a computer-implemented Post-Hoc Optimal (PHO) Method for calculating a suggested reserve price associated with a cluster 700.

Before describing the computer implementation of the method, the PHO Method is first introduced as follows. Assuming that there are n historical online advertisement auctions in the cluster 700, according to the example embodiment, the PHO Method may first group all the 1^{st} bid prices F₁˜Fₙ of the n historical online advertisement auctions in the cluster 700 into group 910 and group all the 2^{nd} bid prices S₁˜Sₙ of the n historical online advertisement auctions in the cluster 700 in to group 920. The bid prices of each group may be arranged in a particular order, so that the 2 groups are one-to-one mapping with respect to each other. For example, the 1^{st} bid prices may be listed in ascending order, i.e.:

F₁≦F₂≦ . . . ≦Fₙ,

and the 2^{nd} bid may be listed in ascending order, i.e.:

S₁≦S₂≦ . . . ≦Sₙ.

Next, the PHO Method may create a group of candidate reserve prices 930 including m candidate prices r₁-rₘ. The group of m candidate reserve prices 930 may be a subgroup of the 1^{st} bid prices 910, which provides m≦n, and each of the m candidate prices r₁-rₘ is a 1^{st} bid price from group 910. The PHO Method then may treat each corresponding pair of prices (e.g. Fⱼ-Sⱼ pair) from groups 910 and 920 as the 1^{st} bid price and 2^{nd} bid price of an imaginary auction. For a particular candidate reserve price rᵢ among r₁-rₘ, in group 930, the PHO Method may calculate revenue of each of the n imaginary auctions represented by groups 910 and 920 under the second-price rule. The PHO Method then may sum the revenues of the n imaginary auctions to obtain accumulative revenue R. The accumulative revenue R thus may represent expected total revenue for n online advertisement displays (e.g., n impressions, n clicks, n acquisitions, and/or any other online advertisement auction methodology known in the art) that associate with n opportunities similar to that of the cluster if the publisher 404 set each reserve price as rᵢ.

To obtain maximum and/or desired revenue for the cluster 700, the PHO method may calculate accumulative revenue R that corresponds to each candidate reserve price r₁-rₘ in group 930 (thus obtain a group of cumulative revenue being one-to-one mapping of the candidate reserve price group 930) and select the maximum accumulative revenue Rₘₐₓ and/or desired accumulative revenue. The PHO Method may then return the corresponding candidate reserve price as a suggest reserve price r_{suggested} for an online advertisement display opportunity that is substantially similar to that of the cluster 700.

Next, the computer implementation of the PHO Method as shown in FIG. 9 is described. According to an example embodiment, a server 416 that operates a program 420 adopting PHO Method may first group all the 1^{st} bid prices F₁˜Fₙ of the n historical online advertisement auctions 710 in the cluster 700 into group 910 and group all the 2^{nd} bid prices S₁˜Sₙ of the n historical online advertisement auctions 710 in the cluster 700 into group 920. The bid prices of each group may be arranged in a particular order, so that the two groups 910, 920 are one-to-one mapping with respect to each other. For example, the 1^{st} bid prices may be listed in ascending order, i.e.:

F₁≦F₂≦ . . . ≦Fₙ,

and the 2^{nd} bid may be listed in ascending order, i.e.:

S₁≦S₂≦ . . . ≦Sₙ.

Next, the server 416 may operate the program 420 to create a group of candidate reserve prices 930, which includes m candidate prices r₁-rₘ. The group of m candidate reserve prices 930 may be a subgroup of the 1^{st} bid prices 910, i.e., m≦n, and each of the m candidate prices r₁-rₘ may be a 1^{st} bid price from group 910. FIG. 9 shows a situation where m=n, i.e., the candidate reserve price group 930 equals the 1^{st} bid price group 910.

The server 416 may then operate the program 420 to create two numerical variables Rₘₐₓ and r_{suggested} as well as two pointer variables i and j, wherein the two pointer variables i, j respectively point to the i^{th} and j^{th} prices in groups 930 and 920. In step 941, the server 416 may operate the program 420 to assign an initial value to each variable. For example:

i=1,j=0,r_{suggested}=0, and

Rₘₐₓ=Σₚ₌₁ⁿSₚ.

Then, in step 942, the server 416 may operate the program 420 to assign to a numerical variable r the value of an i^{th} candidate reserve price rᵢ in group 930. The server 416 may then decide in step 943 whether the j^{th} value Sⱼ of the 2^{nd} bid price group 920 is lesser than the value of variable r. If yes, the server 416 may operate the program 420 to move the pointer variable j to the next 2^{nd} bid price in group 920, i.e. to increase the value j by 1, as shown in step 944, until it finds a value Sⱼ≧r. At that point, the server 416 may operate the program 420 to compute cumulative revenue:

R=r(j−i)+Σₚ₌ⱼⁿSₚ,

as shown in step 945.

In steps 946-947, the server 416 may operate the program 420 to decide whether the cumulative revenue R is greater than the numerical variable Rₘₐₓ. If yes, the server 416 may operate the program 420 in step 947 to assign the value of the cumulative revenue R to the numerical variable Rₘₐₓ and assign the numerical variable r_{suggested} the value of r before proceeding to step 948. If the cumulative revenue R is not greater than the numerical variable Rₘₐₓ, the server 416 may operate the program 420 to directly move to step 948. At step 948, the server 416 may decide to end the program 420 if the pointer variable i has already pointed to the last candidate reserve price in group 930. Otherwise, the server 416 may operate the program to move the pointer variable i to the next candidate reserve price at step 949, i.e., i=i+1, return to step 942, and operate the loop between steps 942-948 again until the pointer variable i reaches the last candidate reserve price in group 930. When the server 416 finishes the loop between steps 942-949, the server 416 may return and store the value of r_{suggested} in the medium 418 as a suggested reserve price associated with the cluster 700, so that when there is an online advertisement display opportunity that is substantially similar to that of the cluster 700, the publisher 404 may use the suggested reserve price r_{suggested} as the reserve price 422 for the auction 412.

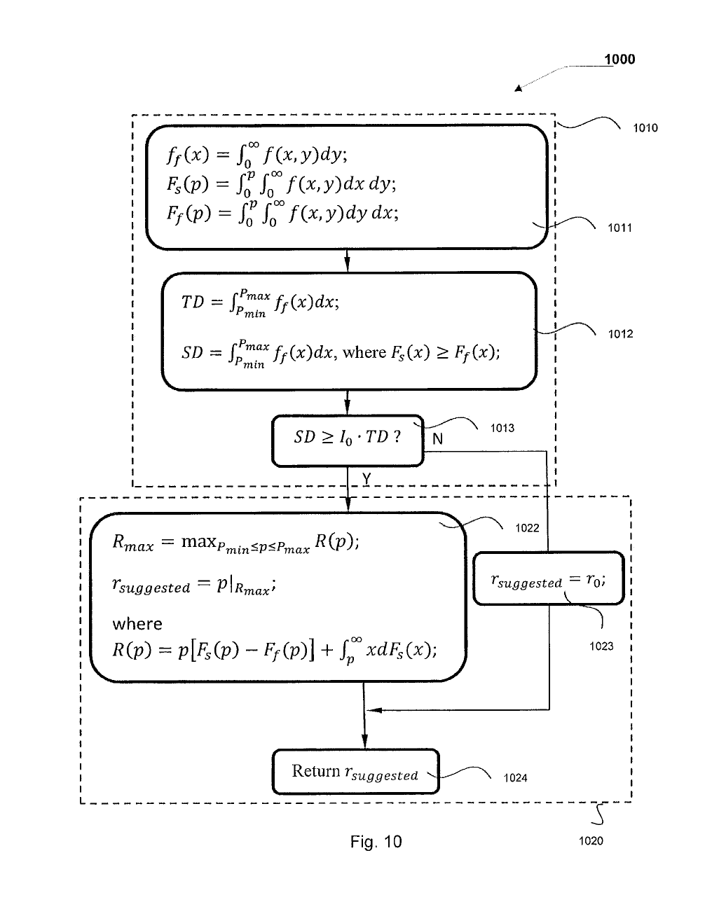

Next, there is provided another suggested reserve price calculating method other than the PHO Method. FIG. 10 is a flow chart of one implementation of a Brute-Force Parametric (BFP) Method for calculating a suggested reserve price. In this implementation, the BFP Method utilizes a cluster 700 of the decision tree in FIG. 6 as an example database to generate standard deviations of the 1^{st} bid and the 2^{nd} bid. However, the required deviation data in the BFP Method is not algorithm specific, i.e., the BFP Method may utilize any regression algorithm to generate an estimate of the 1^{st} bid and its standard deviation, and an independent estimate of the 2^{nd} bid and its standard deviation.

Referring to FIG. 10, the BFP Method may include a stochastic dominance test 1010 and a calculation 1020 for a suggested reserve price of the cluster 700. Test 1010 may tests a stochastic dominance relationship of the 1^{st} bid price distribution and the 2^{nd} bid price distribution associated with a cluster 700. For an individual historical online advertisement auction 710, a 1^{st} bid price is always equal to or greater than a 2^{nd} bid price. However, when data of a number of historical online advertisement auctions are collected and grouped, the 1^{st} bid price distribution of the group may not always dominate the 2^{nd} bid price distribution of the group. For example, when both distributions are lognormal, neither will stochastically dominate the other unless the variances of the distributions are equal. In conducting the BFP Method, test 1010 may first ensure that over a range of reserve price being considered, the 2^{nd} bid price is generally lower than the 1^{st} bid price.

Referring to FIG. 10, step 1011 of test 1010 may include obtaining f(x,y), which is a joint distribution function of the 1^{st} bid prices (represented by x in f(x,y)) and the 2^{nd} bid prices (represented by y in f(x,y)) of a cluster 700. Accordingly, the distribution function for the 1^{st} bid prices in the cluster 700 may be expressed as:

f_{f}(x)=∫₀^{∞}f(x,y)dy;

the probability that a 1^{st} bid price in the cluster 700 falls between [0, p] may be expressed as:

Fₛ(p)=∫₀^{p}∫₀^{∞}f(x,y)dxdy,

and the probability that a 2^{nd} bid price in the cluster 700 falls between [0,p] may be expressed as:

F_{f}(p)=∫₀^{p}∫₀^{∞}f(x,y)dydx.

Next, in step 1012, the test 1010 may calculate a total density value using the equation:

TD=∫_{P}_{ₘᵢₙ}^{P}^{ₘₐₓ}f_{f}(x)dx,

meaning the probability of a 1^{st} bid price of an historical online advertisement auction 710 in the cluster 700 falls between the price range [Pₘᵢₙ, Pₘₐₓ]. The test 1010 may also calculate a stochastic density SD, meaning the probability that the 1^{st} bid price is equal to or greater than the 2^{nd} bid price at any point between [Pₘᵢₙ, Pₘₐₓ] weighed by the 1^{st} bid price distribution f_{f}(x) at that point. The expression of SD may be:

SD=∫_{P}_{ₘᵢₙ}^{P}^{ₘₐₓ}f_{f}(x)dx,

but SD only has value when F_{S}(x)≧F_{f}(x). Finally, the test 1010 may determine in step 1013 whether the probability that the 1^{st} bid price is equal to or greater than the 2^{nd} bid price is higher than a threshold value I₀, i.e.,

SD≧I₀·TD.

If the test 1010 determines

SD<I₀·TD,

the 1^{st} bid price distribution may not dominate the 2^{nd} bid price distribution to an extent as wished. In this situation, the BFP Method may return a nominal reserve price r₀ as a suggested reserve price, as shown in step 1023. If the test 1010 determines

SD≧I₀·TD,

the 1^{st} bid price distribution may dominate the 2^{nd} bid price distribution to an extend as wished. The BFP Method may calculate between a price range [Pₘᵢₙ, Pₘₐₓ] a suggested reserve price r_{suggested} associated with maximum and/or desired revenue expectation for the cluster 700, as shown in step 1022 of the calculation 1020. In some implementations, the revenue expectation may be expressed as:

R(p)=p[Fₛ(p)−F_{f}(p)]+∫ₚ^{∞}xdFₛ(x).

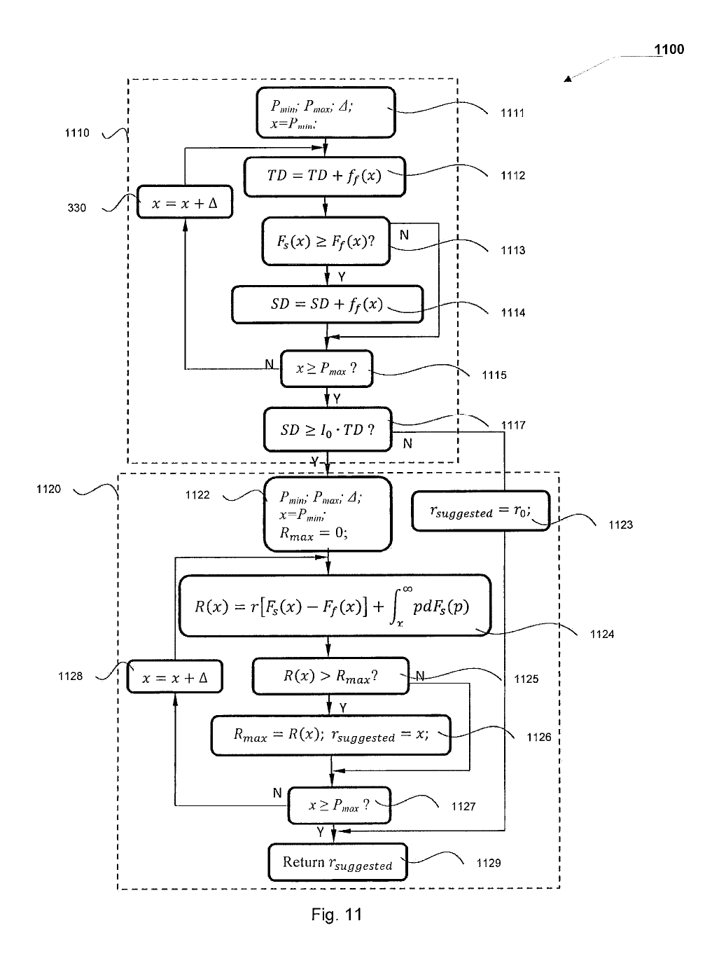

Next, a computer implementation of the BFP Method is described. FIG. 11 shows one implementation of a flow chart of a computer-implemented program adopting the BFP Method. According to FIG. 8, the computer-implemented BFP Method may include a stochastic dominance test 1110 of a cluster 700 and a calculation 1120 for a suggested reserve price of the cluster 700.

In test 1110, a server 416 may operate the program 420 to test the stochastic dominance relationship of the 1^{st} bid price distribution and the 2^{nd} bid price distribution associated with a cluster 700. As shown in step 1111, the program may first assign price boundaries [Pₘᵢₙ, Pₘₐₓ] of the calculation. Using a price variable x with a step increment d, the test 1110 may test the stochastic dominance relationship of the and 2^{nd} price distributions point by point between [Pₘᵢₙ, Pₘₐₓ].

Over the loop 1112-1116, the server 416 may operate the program 420 to calculate a total density value TD (step 1112). TD may take a form

TD=TD+f_{f}(x)

as an approximation to the integral of f_{f}(x) over the range [Pₘᵢₙ, Pₘₐₓ], which represents the probability that the first bid falls in that range. The loop between steps 1112-1116 may also calculate a stochastic density SD (step 1114) subject to a condition that

Fₛ(x)≧F_{f}(x)(step 1113).

SD may take a form

SD=SD+f_{f}(x),

representing an approximation to the integral of f_{f}(x) over the range [Pₘᵢₙ, Pₘₐₓ]. SD thus may represent a probability that the 1^{st} bid price is equal to or greater than the 2^{nd} bid price over the range [Pₘᵢₙ, Pₘₐₓ] weighed by the probability that the 1^{st} bid price falls into that range.

After finishing the loop between steps 1112 and 1116, the server 416 may operate the program 420 to decide in step 1117 whether

SD≧I₀·TD,

i.e., whether the probability that the 1^{st} bid price is equal to or greater than the 2^{nd} bid price is higher than a threshold value I₀. The value of I₀ may be around 0.9.

Now referring to the calculation step 1120, if the test 1110 determines

SD<I₀·TD,

the distributions may not behave nicely as wished, i.e., the 1^{st} bid price distribution may not dominate the 2^{nd} bid price distribution to an extent as wished. The server 416 may operate the program 420 to assign a nominal reserve price r₀ as a suggested reserve price r_{suggested} (step 1123). The nominal reserve price r₀ may be a minimal reserve price acceptable for an opportunity of online advertisement display that is substantially similar to that of the cluster 700.

If the test 1110 determines

SD≧I₀·TD,

the 1^{st} bid price distribution may dominate the 2^{rd} bid price distribution to an extent as wished. The server 416 may operate the program 420 to assign a price range [Pₘᵢₙ, Pₘₐₓ] and a step increment value Δ, and calculate point by point with the increment Δ between a price range [Pₘᵢₙ, Pₘₐₓ] (step 1122) a suggested reserve price associated with maximum and/or desired revenue expectation for an opportunity of online advertisement display that is substantially similar to that of the cluster 700, as shown in the loop of steps 1124-1128. The set of price range and increment value may or may not be the same as used in test 1110.

In some implementations, the revenue expectation may be expressed as:

R(x)=r[Fₛ(x)−F_{f}(x)]+∫ₓ^{∞}pdFₛ(p),

as shown in step 1124. In steps 1125-1126, the server may operate the program to find the highest revenue expectation value, saved as Rₘₐₓ, and its corresponding reserve price value, saved as r_{suggested}. Further, steps 1127 and 1128 may function to keep the loop of steps 1124-1128 running until the server 416 finishes the calculation between the price range [Pₘᵢₙ, Pₘₐₓ].

When the server 416 finishes the steps between steps 1122-1129, the server 416 may return and store the value of r_{suggested} in the medium 418 as a suggested reserve price associated with the cluster 700. When the there is an online advertisement display opportunity that is substantially similar to that of the cluster 700, the publisher 404 may use the suggested reserve price r_{suggested} as the reserve price 422 for the auction 412.

As described above, systems and computer-implemented methods may provide automated reserve-price computation that publishers may use to optimize the yield on their inventory. In some implementations, the described systems and methods may compute a reserve price using bidding data of a cluster of similar historical online advertisement auctions and a Brute-Force Parameter model. In other implementations, the described systems and methods may compute a reserve price using bidding data of a cluster of similar historical online advertisement auctions and a Post-Hoc Optimal model. In addition, the present application also provides programs adopting that described methods, where the programs comprise instructions stored on a computer-readable storage medium that may be executed by a processor of a device such as servers.

However, it is intended that the foregoing detailed description be regarded as illustrative rather than limiting, and that it be understood that it is the following claims, including all equivalents, that are intended to define the spirit and scope of this invention.

For example, while the above-described systems and methods have been described with respect to optimizing yields of advertisement display auctions, it will be appreciated that the same systems and methods may be implemented to optimize the yields of auctions that are not related to advertisement display.

Further, while the above-described systems and methods have been described with respect to optimizing the yields of online auctions, it will be appreciated that the same systems and methods may be implemented to optimize the yields of auctions that are not held online and/or not related to online activities.

Also, while the above-described systems and methods have been described with respect to optimizing the yields of auctions held by publishers and bided by advertisers, it will be appreciated that the same systems and methods may be implemented to optimize the yields of auctions held by any auction holder and bided by any auction attendances.

In addition, while example embodiments have been particularly shown and described with reference to FIGS. 1-11, it will be understood by one of ordinary skill in the art that various changes in form and details may be made therein without departing from the spirit and scope of example embodiments, as defined by the following claims. The example embodiments, therefore, are provided merely to be illustrative and subject matter that is covered or claimed is intended to be construed as not being limited to any example embodiments set forth herein. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof. The following detailed description is, therefore, not intended to be taken in a limiting sense.

Throughout the specification and claims, terms may have nuanced meanings suggested or implied in context beyond an explicitly stated meaning. Likewise, the phrase “in one embodiment” or “in one example embodiment” as used herein does not necessarily refer to the same embodiment and the phrase “in another embodiment” or “in another example embodiment” as used herein does not necessarily refer to a different embodiment. It is intended, for example, that claimed subject matter include combinations of example embodiments in whole or in part.

The terminology used in the specification is for the purpose of describing particular embodiments only and is not intended to be limiting of example embodiments of the invention. In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Likewise, it will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof, and in the following description, the same reference numerals denote the same elements.

We claim:

1. A computer-implemented method of calculating a suggested reserve price associated with an opportunity to realize an online advertisement, the method comprising:
establishing a database of historical online advertisement auctions;
clustering historical online advertisement auctions from the database of historical online advertisement auctions that are associated with a feature to form a cluster;
calculating a reserve price associated with the cluster of historical online advertisement auctions to generate a desired revenue; and
storing the reserve price as a suggested reserve price for the opportunity to realize the online advertisement that is associated with the feature.

2. The computer-implemented method according to claim 1, further comprising:
receiving information of an online advertisement auction from a publisher;
identifying that a feature of the online advertisement auction is substantially the same as the feature of the historical online advertisement auctions of the cluster; and
returning the suggested reserve price of the cluster to the publisher.

3. The computer-implemented method according to claim 1, wherein computing the reserve price comprises:
computing for the historical online advertisement auctions in the cluster a group of cumulative revenues that corresponds with a group of candidate reserve prices, wherein the group of cumulative revenue is a one-to-one mapping to the group of candidate reserve prices;
finding the desired revenue among the group of cumulative revenues; and
returning the reserved price that is corresponding with the desired revenue as the suggested reserve price.

4. The computer-implemented method according to claim 3, wherein computing a cumulative revenue comprises:
identifying for each of the historical online advertisement auctions in the cluster a first bid price and a second bid price, wherein the first bid price is greater than the second bid price;
grouping the first bid price into a first group and the second bid price into a second group, wherein the first group is a one-to-one mapping of the second group;
identifying a candidate reserve price of the group of candidate reserve prices that corresponds with the cumulative revenue;
computing an individual revenue to each corresponding pair of the first and second bid prices in the first and second groups; and
summing the individual revenue of each pair of the first and second bid prices in the first and second groups;
wherein the individual revenue for a pair of the first and second bid prices in the first and second groups equals zero when the corresponding reserve price is greater than the first price associated with the historical online advertisement auction; and
wherein the individual revenue pair of the first and second bid prices in the first and second groups equals the greater of the corresponding reserve price and the second bid price associated with the historical online advertisement auction when the corresponding reserve price is not greater than the first price.

5. The computer-implemented method according to claim 4, wherein
the group of reserve prices is a subset of the first group of auctions in the cluster;
the first bid prices in the first group is in an ascending order; and
the second bid prices in the second group is in an ascending order.

6. The computer-implemented method according to claim 1, wherein the feature is at least one of information related to a section of a webpage of the publisher space where an online advertisement is shown, a Uniform Resource Locater of a webpage of the publisher space where an online advertisement is shown, a size of an online advertisement, user demographic information, geographic information about a user, and user information stored in cookies; and
the realization of an online advertisement comprises at least one of an impression of an online advertisement, a click-through associated with an online advertisement, an action associated with an online advertisement, an acquisition associated with an online advertisement, and a conversion associated with an online advertisement.

7. The computer-implemented method according to claim 1, wherein:
the dataset comprises a plurality of sections;
each historical online advertisement auction in the cluster is associated with a first bid price and a second bid price;
at least one of the plurality of sections is configured as a decision-tree; and
the cluster is a leaf of the decision tree.

8. The computer-implemented method according to claim 1, wherein the cluster is formed periodically within a first time period, and the reserve price is calculated periodically within a second period.

9. A server comprising:
a computer-readable storage medium storing set of instructions for calculating a suggested reserve price associated with an opportunity to realize an online advertisement;
a processor in communication with the computer-readable storage medium that is configured to execute the set of instructions stored in the computer-readable storage medium and is configured to:
establish a database of historical online advertisement auctions;
cluster historical online advertisement auctions from the database of historical online advertisement auctions that are associated with a feature to form a cluster;
calculate a reserve price associated with the cluster of historical online advertisement auctions to generate a desired revenue; and
store the reserve price as a suggested reserve price for the opportunity to realize the online advertisement that is associated with the feature.

10. The server of claim 9, wherein the processor is further configured to:
receive information of an online advertisement auction from a publisher;
identify that a feature of the online advertisement auction is substantially the same as the feature of the historical online advertisement auctions of the cluster; and
return the suggested reserve price of the cluster to the publisher.

11. The server of claim 9, wherein calculating the reserve price comprises:
computing for the historical online advertisement auctions in the cluster a group of cumulative revenues that corresponds with a group of candidate reserve prices, wherein the group of cumulative revenue is a one-to-one mapping to the group of candidate reserve prices;
finding the desired revenue among the group of cumulative revenues; and
returning the reserved price that is corresponding with the desired revenue as the desired price.

12. The server of claim 11, wherein computing the cumulative revenue comprises:
identifying for each of the historical online advertisement auctions in the cluster a first bid price and a second bid price, wherein the first bid price is greater than the second bid price;
grouping the first bid price into a first group and the second bid price into a second group, wherein the first group is a one-to-one mapping of the second group;
identifying a candidate reserve price of the group of candidate reserve prices that corresponds with the cumulative revenue;
computing an individual revenue to each corresponding pair of the first and second bid prices in the first and second groups; and
summing the individual revenue of each pair of the first and second bid prices in the first and second groups;
wherein the individual revenue for a pair of the first and second bid prices in the first and second groups equals zero when the corresponding reserve price is greater than the first price associated with the historical online advertisement auction; and
wherein the individual revenue for the pair of the first and second bid prices in the first and second groups equals the greater of the corresponding reserve price and the second bid price associated with the historical online advertisement auction when the corresponding reserve price is not greater than the first price.

13. The server of claim 9, wherein the feature is at least one of information related to a section of a webpage of the publisher space where an online advertisement is shown, a Uniform Resource Locater of a webpage of the publisher space where an online advertisement is shown, a size of an online advertisement, user demographic information, geographic information about a user, and user information stored in cookies; and
the realization of an online advertisement comprises at least one of an impression of an online advertisement, a click-through associated with an online advertisement, an action associated with an online advertisement, an acquisition associated with an online advertisement, and a conversion associated with an online advertisement.

14. The server of claim 11, wherein:
the dataset comprises a plurality of sections;
each historical online advertisement auction in the cluster is associated with a first bid price and a second bid price;
at least one of the plurality of sections is configured as a decision-tree;
the cluster is a leaf of the decision tree;
the group of reserve prices is a subset of the first group of auctions in the cluster;
the first bid prices in the first group is in an ascending order; and
the second bid prices in the second group is in an ascending order.

15. A computer-readable storage medium comprising a set of instructions for calculating a suggested reserve price associated with an opportunity to realize an online advertisement, the set of instructions to direct a processor to perform acts of:
establishing a database of historical online advertisement auctions;
clustering historical online advertisement auctions from the database of historical online advertisement auctions that are associated with a feature to form a cluster;
calculating a reserve price associated with the cluster of historical online advertisement auctions to generate a desired revenue; and
storing the reserve price as a suggested reserve price for the opportunity to realize the online advertisement that is associated with the feature.

16. The computer-readable storage medium of claim 15, wherein the acts further comprising:
receiving information of an online advertisement auction from a publisher;
identifying that a feature of the online advertisement auction is substantially the same as the feature of the historical online advertisement auctions of the cluster; and
returning the suggested reserve price of the cluster to the publisher.

17. The computer-readable storage medium claim 15, wherein calculating the reserve price comprises:
computing for the historical online advertisement auctions in the cluster a group of cumulative revenues that corresponds with a group of candidate reserve prices, wherein the group of cumulative revenue is a one-to-one mapping to the group of candidate reserve prices;
finding the desired revenue among the group of cumulative revenues; and
returning the reserved price that is corresponding with the desired revenue as the desired price.

18. The computer-readable storage medium of claim 17, wherein computing the cumulative revenue comprises:
identifying for each of the historical online advertisement auctions in the cluster a first bid price and a second bid price, wherein the first bid price is greater than the second bid price;
grouping the first bid price into a first group and the second bid price into a second group, wherein the first group is a one-to-one mapping of the second group;
identifying a candidate reserve price of the group of candidate reserve prices that corresponds with the cumulative revenue;
computing an individual revenue to each corresponding pair of the first and second bid prices in the first and second groups; and
summing the individual revenue of each pair of the first and second bid prices in the first and second groups;
wherein the individual revenue for a pair of the first and second bid prices in the first and second groups equals zero when the corresponding reserve price is greater than the first price associated with the historical online advertisement auction; and
wherein the individual revenue for the pair of the first and second bid prices in the first and second groups equals the greater of the corresponding reserve price and the second bid price associated with the historical online advertisement auction when the corresponding reserve price is not greater than the first price.

19. The computer-readable storage medium of claim 15, wherein
the feature is at least one of information related to a section of a webpage of the publisher space where an online advertisement is shown, a Uniform Resource Locater of a webpage of the publisher space where an online advertisement is shown, a size of an online advertisement, user demographic information, geographic information about a user, and user information stored in cookies; and
the realization of an online advertisement comprises at least one of an impression of an online advertisement, a click-through associated with an online advertisement, an action associated with an online advertisement, an acquisition associated with an online advertisement, and a conversion associated with an online advertisement;

20. The computer-readable storage medium of claim 18, wherein
the dataset comprises a plurality of sections;
each historical online advertisement auction in the cluster is associated with a first bid price and a second bid price;
at least one of the plurality of sections is configured as a decision-tree;
the cluster is a leaf of the decision tree;
the group of reserve prices is a subset of the first group of auctions in the cluster;
the first bid prices in the first group is in an ascending order; and
the second bid prices in the second group is in an ascending order.
